(19) United States
(12) Patent Application Publication
(10) Pub. No.: US 2011/0115972 A1
(43) Pub. Date: May 19, 2011

(54) HEATING DEVICE FOR HEATING A GLASS SURFACE, PARTICULARLY A PROTECTICE GLASS OF AN OUTDOOR CAMERA, AND ELECTRONIC AND/OR OPTICAL DEVICE HAVING A PROTECTIVE GLASS

(76) Inventor: Axel Voges, Wendlingen (DE)

(21) Appl. No.: 12/737,455

(22) PCT Filed: Jun. 10, 2009
(86) PCT No.: PCT/EP2009/057178

§ 371 Date: Jan. 14, 2011

(30) Foreign Application Priority Data
Jul. 16, 2008 (DE) 10 2008 033 316.6

(51) Int. Cl. H04N 5/225; H05B 3/10; G03B 17/00

(52) U.S. Cl. 348/373; 219/553; 396/427; 348/E05.026

(57) ABSTRACT

At least one heating element is applied to a glass surface as a material layer to provide a heating device for heating the glass surface. Due to such direct heating of the glass surface, such as a protective glass, in that the material layer applied in a positive, bonded and non-positive manner, the energy input necessary for heating is low, and the heating is carried out in a uniform manner free of interferences.

### CROSS REFERENCE TO RELATED APPLICATIONS

This application is the U.S. national stage of International Application No. PCT/EP2009/057178, filed Jun. 10, 2009 and claims the benefit thereof. The International Application claims the benefits of German Application No. 102008033316.6 filed on Jul. 16, 2008, both applications are incorporated by reference herein in their entirety.

### BACKGROUND

Described below is a heating device for heating a glass surface, particularly a protective glass of an outdoor camera, for example a monitoring camera on a vehicle or at a traffic intersection. Furthermore, the heating device relates to an electronic and/or optical device, particularly an outdoor camera having a protective glass.

The heating of protective glasses for cameras in outdoor use is required in order to avoid fogging, condensation and icing.

The protective glasses are usually heated indirectly in the case of cameras for outdoor use. This is implemented, for example, by power resistors and/or wound heating elements that are arranged in the region of the protective glass, for example on or around the protective glass. Such indirect heating exhibits a high energy requirement.

It is also customary to apply thin heating wires directly to the protective glass. This can usually lead to disturbances of the camera recorders and to non-uniform heating of the protective glass surface.

### SUMMARY

Described below is an improved heating device which enables homogeneous heating of the heating surface.

The heating device for heating a glass surface includes at least one heating element that is applied to the protective glass as a material layer. In one possible embodiment, the glass surface is a protective glass of an optical and/or electronic device, particularly an outdoor camera. The material layer may be connected to at least two electrical contact elements formed from metallic strips.

The material layer applied directly to the glass surface enables direct heating, there thus being a need for less energy by comparison with known instances of indirect heating. Moreover, a coating applied over the entire face, or else applied only in regions, enables the entire face or the relevant regions to be heated uniformly and, for example, thus enables uniform deicing of the glass surface, for example a protective glass.

One possible embodiment of such direct heating provides that the material layer be applied in a positive, bonded and/or non-positive fashion. Making such direct contact between the face and thus the effective area of the glass surface and material layer enables heat transfer that is direct and therefore very good, as a result of which energy input required for heating is low. The material layer may be formed from a plurality of layers applied one over another.

In one possible embodiment, the material layer can be applied to one or both faces of the glass surface, thus enabling adaptation of the heating power.

The material layer may be applied as a homogeneous layer. A homogeneously applied material layer ensures that the heating is performed uniformly and that there is no occurrence of instances of image interference that usually occur from non-uniform heating, for example by heating wires, and thus from non-uniform thawing of the glass surface, particularly the protective glass.

One further possible embodiment provides that the material layer is formed at least from a transparent material. Influences by image-interfering elements are thereby largely avoided.

The material layer may be formed from a conductive material. This constitutes a particularly simple and cost-effective embodiment. For example, a material layer formed from a conductive material forms a particularly simple type of resistance heating, particularly as surface resistance heating.

The material layer is advantageously formed from indium tin oxide or carbon nanotubes. Again, as an alternative to these substances it is also possible to make use of other substances having substantially the same properties, such as, for example, tin(IV) oxide doped with fluorine, zinc oxide doped with aluminum, or tin(IV) oxide doped with antimony. These abovenamed substances enable a transparency that is high for camera applications or spotlight applications, in conjunction with low color distortion. Equally, further materials can be applied when these have the desired properties, particularly a high transparency and color distortion that is as low as possible.

In one possible development, the material layer can be applied in regions, for example only in the region immediately in front of an objective of the camera. The protective glass can thereby be heated selectively with extremely little energy. Such an embodiment additionally requires less material for the heating layer and is therefore cost effective.

Moreover, the material layer is made from a material with a high color fidelity. Color distortions of camera recordings are thereby largely avoided.

The material layer may be designed as a surface resistance. This embodiment enables uniform heating and low energy use.

The material layer may be applied with a prescribable thickness, particularly with a thickness of a few nanometers, for example from 100 nm to 1000 nm, particularly from 200 nm to 400 nm, or from 250 nm to 350 nm, for example of approximately 300 nm. Such a small thickness of the material layer particularly saves material, and enables the glass surface, for example the protective glass, to be heated cost effectively and in a fashion saving energy. In addition, uniform heating of the protective glass surface is ensured, and a high transparency and color fidelity of the protective glass surface are enabled.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic of a glass surface, for example a protective glass, with an all-over heating layer for an outdoor camera, in a sectional illustration,

FIG. 2 is a schematic of a glass surface, for example a protective glass, with an all-over heating layer for an outdoor camera, in plan view,

FIG. 3 is a schematic of a glass surface, for example a protective glass, with a partial heating layer, in plan view, and

FIG. 4 is a schematic of an outdoor camera.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

Mutually corresponding parts are provided in all the figures with the same reference numerals.

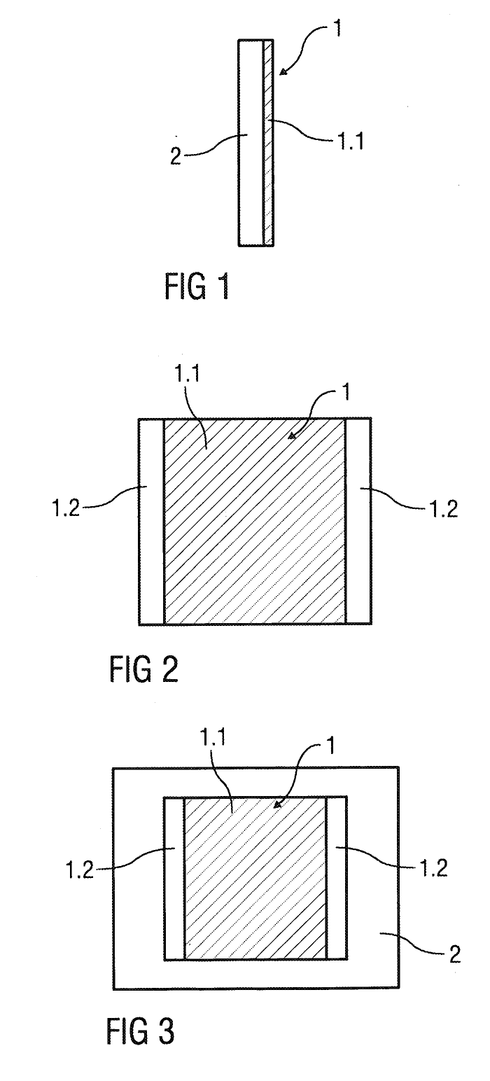

FIG. 1 shows a heating device 1 for heating a glass surface 2, for example a protective glass of by way of example an outdoor camera for a vehicle or a monitoring device, for example a traffic monitoring camera at traffic points such as, for example, in tunnel installations, at road intersections, or other suitable optical and/or electronic devices such as, for example, spotlights, or other mobile units.

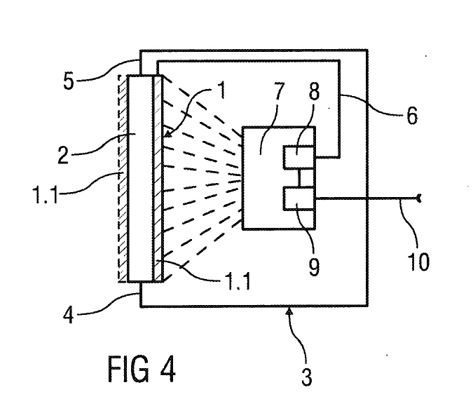

The outdoor camera that is illustrated in more detail in FIG. 4 is, in particular, a known image recording device, for example a video camera or a CCD image sensor (CCD=charge-coupled device). The outdoor camera in this case has at least one data processing unit and a communication unit. The communication unit is designed as an Ethernet connection. Owing to the direct heating of the glass surface 2 by the heating device 1, and to the design of the outdoor camera as a CCD camera, a small amount of power is sufficient in order to supply both the outdoor camera and the heating device 1. In order to supply the two components simply, it is provided that the outdoor camera and the heating device 1 are supplied with current via the Ethernet connection.

For the purpose of greater clarity, the glass surface 2 is denoted below as protective glass 2.

The protective glass 2 protects the outdoor camera particularly against mechanical and/or thermal loads, for example against dampness, dust, aerosols, wind, radiation, electrostatic discharges and/or mechanical vibrations, for example in the case of mobile units or when applied in a vehicle. To this end, the protective glass 2 is made, in particular, from antireflective glass or from glass with a coating for antireflectivity. The protective glass 2 is also made, in particular, from a material particularly resistant to heat and cold, in particular a scratchproof material. For example, the protective glass 2 is made from normal glass or from a glass-like material such as, for example, a thermoplastic such as polymethyl methacrylate (also termed acrylic glass) or polycarbonate.

The heating device 1 includes a heating element that is applied to the protective glass 2 as a material layer 1.1.

The material layer 1.1 may be applied to at least one of the faces of the protective glass 2 in a positive, bonded and/or non-positive fashion as well as homogeneously.

Depending on use and environmental conditions, the material layer 1.1 is applied to the protective glass 2 with a prescribed thickness. For example, the material layer 1.1 is applied with a thickness in the nanometer range, for example from 100 nm to 1000 nm, particularly from 200 nm to 400 nm, or from 250 nm to 350 nm, for example of approximately 300 nm.

The material layer 1.1 may be formed from at least one electrically conductive material of high transparency and/or color fidelity. The use of transparent materials of high color fidelity for the material layer 1.1 enables the exclusion of the influence of elements which disturb images or disturb optics.

The material layer 1.1 can in this case be applied using a known plasma coating method, for example a so-called sputtering, CVD, PCVD coating method, or other suitable mechanical, thermal and/or chemical coating methods such as, for example, by immersion, spraying, printing, spin-coating, or vapor deposition, particularly by high-vacuum vapor deposition.

Such a material layer 1.1 formed from electrically conductive material enables a surface resistance that forms simple surface resistance heating, and thus a heating layer, upon application of a voltage.

The material layer 1.1 may be made from indium tin oxide (ITO, for short), or carbon nanotubes. Alternatively, the transparent and conducting material layer 1.1 can be formed from fluorine-doped tin(IV) oxide (called FTO=fluorine tin oxide, for short), from aluminum-doped zinc oxide (called AZO=aluminum zinc oxide, for short), or antimony-doped tin(IV) oxide (called ATO=antimony tin oxide, for short).

In this case, the material layer 1.1 can be formed from a plurality of layers, applied one over another, and thus a plurality of resistance heating layers. There can also be a single layer.

FIG. 2 shows a possible embodiment for the application of the material layer 1.1 as a coating completely covering the face of the protective glass 2. The protective glass 2 can in this case be provided on the upper and/or lower side with the material layer 1.1. It is desirable for the protective glass 2 to be provided with the material layer 1.1 on an upper side of the protective glass 2 that lies inside, that is to say is aligned with the interior of the camera or with the interior of the spotlight, and thus on the upper side lying opposite the environment.

In order to apply a voltage to the material layer 1.1 designed as at least one or more resistance heating layers, the material layer has at least two contact elements 1.2. These contact elements 1.2 are arranged, for example, to the side of the material layer 1.1 on mutually opposite sides.

The contact elements 1.2 are, for example, formed from metallic strips, for example from copper foil strips. In this case, the contact elements 1.2 are applied, for example, to the material layer 1.1 with the aid of electrically conductive, particularly silver-filled adhesive. Alternatively, the contact elements 1.2 can be integrated in the material layer 1.1, for example be injected or cast there in.

During operation of the heating device 1, the contact elements 1.2 are used to guide electrical energy into the surface resistance formed by the material layer 1.1. The surface resistance of the material layer 1.1 effects heating of the latter, and also of its surroundings. This heat effects the heating of the protective glass 2.

Thus, directly applying the material layer 1.1 to the protective glass 2 produces the heat where it is required. This reduces the energy use.

It is particularly desirable for the material layer 1.1 to be applied homogeneously to the protective glass 2, and to remain thus applied. Such a homogeneous and directly acting material layer 1.1 enables uniform heating of the protective glass 2 so that aberrations or optical errors by, for example, only a partial melting of an ice layer are reliably avoided.

FIG. 3 shows an alternative embodiment of a heating device 1. In this case, the material layer 1.1 serving as heating element is applied partially, that is to say in regions, to the protective glass 2. The material layer 1.1 may be applied to the outer side of the face of the protective glass 2 only in the region immediately in front of an objective of the outdoor camera. This embodiment constitutes a form of a heating device 1 that saves material and energy.

FIG. 4 shows an outdoor camera 3 that has a housing 4 of weatherproof design and having a cutout 5 in which the protective glass 2 is arranged.

Applied to at least one side of the protective glass 2 is the heating device 1, which has a heating element that is applied to the protective glass 2 as a material layer 1.1.

The protective glass 2 may be provided with the material layer 1.1 on an inner side, that is a side facing an interior of the housing 4. In an alternative embodiment, it is also possible to provide both sides of the protective glass 2 with the material layer 1.1.

In order to apply a voltage to the material layer 1.1, which is designed as at least one or more resistance heating layers, the material layer has at least two contact elements (not illustrated in more detail). These contact elements make contact with a supply line 6.

A camera 7 is arranged in the interior of the housing 4. The camera 7 is designed, for example, as a known CCD image sensor (CCD=charge-coupled device).

At least the data processing unit 8 and the communication unit 9, which are designed, for example, as a so-called embedded controller, are integrated in the camera 7. The data processing unit 8 is coupled to the communication unit 9. The communication unit 9 is designed as an Ethernet connection.

In order to facilitate supply for the two components, it is provided that the camera 7 and the heating device 1 are supplied with current via the Ethernet connection.

The communication unit 9 is connected with the aid of an Ethernet connecting cable 10 to an external data processing unit (not illustrated), for example a conventional personal computer, and/or to a network outside the outdoor camera 3, and the images recorded by the camera 7 are transmitted by the Ethernet connecting cable 10. In addition, control signals can be communicated by the external data processing unit by the Ethernet connecting cable 10.

The supply line 6 of the heating device 1 is connected to the data processing unit 8. Inside the data processing unit 8, the image data of the camera 7 are processed, and the control signals received in the communication unit 9 are used to control the functions of the camera 7 and the heating device 1. It is thereby possible for all the functions of the outdoor camera 3, in particular the function of the heating device 1 and of the camera 7, to be remotely controlled.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d870, 69 USPQ2d1865 (Fed. Cir. 2004).

1-15. (canceled)

16. A heating device for heating a glass surface, comprising:
at least two electrical contact elements formed from metallic foil strips; and
a heating element applied to the glass surface as a material layer, formed from carbon nanotubes and being transparent, connected to the at least two electrical contact elements.

17. The heating device as claimed in claim 16, wherein the glass surface is a protective glass of an optical and/or electronic device.

18. The heating device as claimed in claim 17, wherein the optical and/or electronic device is an outdoor camera.

19. The heating device as claimed in claim 17, wherein the material layer is applied to at least one face of the protective glass in a positive, bonded and/or non-positive fashion.

20. The heating device as claimed in claim 19, wherein the material layer is applied as a homogeneous layer.

21. The heating device as claimed in claim 20, wherein the material layer is formed from a conductive material.

22. The heating device as claimed in claim 21, wherein the material layer is formed at least partially from indium tin oxide.

23. The heating device as claimed in claim 22, wherein the material layer is applied with a thickness from 100 nm to 1000 nm, for example approximately 300 nm.

24. The heating device as claimed in claim 23, wherein the material layer is approximately 300 nm thick.

25. The heating device as claimed in claim 23, wherein the material layer has a high color fidelity.

26. The heating device as claimed in claim 25, wherein the material layer covers at least a subregion of at least one face of the glass surface.

27. The heating device as claimed in claim 26, wherein the material layer completely covers at least one face of the glass surface.

28. The heating device as claimed in claim 27, wherein the electrical contact elements are formed from copper foil.

29. The heating device as claimed in claim 28, wherein the electrical contact elements are applied to the material layer with the aid of electrically conductive adhesive.

30. The heating device as claimed in claim 20, wherein the material layer is a surface resistance.

31. A monitoring unit, comprising:
an optical and/or electronic device with a protective glass; and
a heating device heating the protective glass when supplied with electrical power, including
at least two electrical contact elements formed from metallic foil strips; and
a heating element applied to the protective glass as a material layer, formed from carbon nanotubes and being transparent, connected to the at least two electrical contact elements.

32. The monitoring unit as claimed in claim 31, wherein the monitoring unit is a traffic monitoring camera.
